(19) United States
(12) Patent Application Publication
(10) Pub. No.: US 2003/0220978 A1
(43) Pub. Date: Nov. 27, 2003

(54) System and method for message sender validation

(76) Inventor: Michael J. Rhodes, New York, NY (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/438,622

(22) Filed: May 15, 2003

Related U.S. Application Data
(60) Provisional application No. 60/440,654, filed on Jan. 16, 2003.
(60) Provisional application No. 60/382,930, filed on May 24, 2002.

(51) Int. Cl. G06F 15/16

(52) U.S. Cl. 709/206

(57) ABSTRACT

Systems, methods, and software that implement a challenge protocol to qualify e-mail senders before delivery of e-mail messages. Preferably the challenge protocol is implemented to create minimal burden on human senders, but a significant burden on bulk e-mail programs such that an active disincentive to bulk e-mail practices is provided. Messages from an unrecognized sender are quarantined until the message-designated sender complies with the challenge protocol. Once a sender has complied with the challenge protocol, the sender is included in an inclusion list maintained for the message-designated recipient ID. E-mail messages from senders on the inclusion list can bypass the challenge protocol and be forwarded to the message-designated recipient ID. In particular implementations, periodically or on request, a digest of quarantined messages can be provided to the corresponding recipient ID to allow users an opportunity to manually augment the inclusion list.

### BACKGROUND OF THE INVENTION

1. Prior Applications

The present invention claims the benefit of U.S. Provisional Application No. 60/440,654 filed Jan. 16, 2003 and U.S. Provisional Application No. 60/382,930 filed on May 24, 2003, both of which are incorporated herein by reference in their entirety.

2. Field of the Invention

The present invention relates, in general, to electronic mail (e-mail), and, more particularly, to software, systems and methods for handling delivery of e-mail to lessen the impact of unsolicited bulk e-mail and preferably provide an active disincentive to bulk e-mail practices.

3. Relevant Background

Since the advent of networked computing, electronic messaging, more commonly referred to as “e-mail” or “e-mail”, has been an increasingly common means for communication. Even today, e-mail accounts for the bulk of Internet traffic. E-mail has become a vital component of both electronic and conventional commerce, as well as a tool used by governments, corporations, and individuals to communicate with each other.

Although computers are used to compose and transport messages, e-mail software applications and protocols were developed to support communication between human users. Established protocols have human-readable headers and message content. As a result, e-mail protocols are easily manipulated to hide or obscure the identity of message senders. Unscrupulous advertisers have used these features to automate mass message delivery of advertising messages to both known and unknown recipients. Messages received by such practices are often referred to as unsolicited bulk e-mail (“UBE”) or “spam”.

Bulk e-mail has several effects that undermine the efficiency and efficacy of electronic messaging. From a recipient's perspective, mailboxes are filled with messages from bulk e-mailers such that valuable messages are obscured by numerous spam messages. These messages consume resources including processing power, memory, disk storage and the like on the recipient's machine. Similar problems are encountered by all network resources (e.g., mail servers) that are used to transport the bulk e-mail. It is well-documented that many Internet service providers (ISPs) have been required to purchase additional servers and storage to handle the volume of bulk e-mail delivered to their customers. Moreover, efforts to restrict delivery of bulk e-mail require purchase of additional software and/or more complex configuration of existing mail server software.

Economics are a primary driver of bulk e-mail practices. In current systems, there is little incremental cost incurred by bulk e-mailers in sending or delivering e-mail messages. In effect, this encourages sending bulk e-mail messages to as many recipients as possible so as to effect delivery of as many messages as possible. Some “anti-spam” methodologies attempt to prevent delivery of messages from addresses associated with well-known bulk e-mailers. For example, the “realtime blackhole list” (RBL) maintained by Mail Abuse Prevention System LLC is accessible by subscribing e-mail servers to prevent delivery of messages when the identity of the message sender matches an identity listed on the RBL. Such systems do not work in real time as someone is only added to the RBL after a complaint is filed, and processed. In the mean time, an offending bulk e-mailer may well have closed down, changed its identity, or forged a new identity as e-mail operations continue. Essentially, even though existing systems enable delivery to be interrupted automatically based upon a list of offending e-mail sources, so long as the processes required to update and maintain the lists are slower than the bulk e-mailer's processes for changing identity, the bulk e-mailer will be able to continue with little effective interruption.

However, merely preventing delivery does not discourage sending the bulk e-mail messages. Preventing delivery is a passive disincentive in that it reduces the number of recipient mailboxes that are reached, but does not impose any incremental cost on the bulk e-mail sender. Since the incremental cost of delivering an e-mail is virtually zero, passive disincentives alone do not effectively discourage bulk e-mail practices. A need exists for an e-mail handling system that provides active disincentives in which some penalty is imposed on the bulk e-mailer, preferably in a manner that scales with the level of messages sent.

Active disincentives currently involve legislative attempts to impose penalties for unsolicited bulk e-mail. These legislative attempts, akin to unsolicited fax laws, are not uniformly implemented, and are difficult to enforce. In generally, they require a user to take significant efforts to contact the bulk e-mailer, document unsolicited messages, and eventually sue the bulk e-mailer. Bulk e-mailers, however, are often entities that can not be tracked down and successfully prosecuted, however. As a result of these burdens, legislative solutions have had little effect.

Technology solutions involve systems that prevent delivery of bulk messages. One type of solution involves establishing exclusion lists that identify senders for which e-mail messages will not be forwarded or received. The efficacy of such solutions is undermined because bulk e-mailers are readily able to change their sender identification due to the open nature of e-mail protocols. Server-side implementations include the RBL described above, while client-side implementation involve “killfiles” or block lists and the like maintained on client computers. Significantly, even when bulk messages are successfully prevented, these solutions do not provide any active disincentive that will discourage future mailings. Also, these solutions place a burden on an administrator or the user to continuously maintain the exclusion file. Moreover, to the extent messages are still delivered to the recipient, the bulk-mailing practices consume network bandwidth, computing resources and the like which impose a burden on innocent network users.

An alternative solution involves inclusion lists that contain sender identifications for permitted message senders. All messages not on the inclusion list are not delivered. While inclusion list solutions prevent bulk e-mail delivery, they are difficult to maintain. Because the inclusion list will vary from user to user, these systems have been implemented primarily in client-side applications. This means that the systems involved in mail transport have been fully consumed, even though the user may experience some benefit by having the message discarded before viewing. Significantly inclusion lists run a risk of excluding desired messages from unrecognized sources, and conventional implementations do not provide a mechanism for readily adding previously unrecognized users to the inclusion list. Also, inclusion list approaches fail to provide an active disincentive to bulk e-mailers.

### SUMMARY OF THE INVENTION

Briefly stated, the present invention addresses the above-described problems by providing systems, methods, and software that implement a challenge protocol to qualify e-mail senders before delivery of e-mail messages. Preferably the challenge protocol is implemented to create minimal burden on human senders, but a significant burden on bulk e-mail programs such that an active disincentive to bulk e-mail practices is provided. Messages from an unrecognized sender are quarantined until the message-designated sender complies with the challenge protocol. Once a sender has complied with the challenge protocol, the sender is included in an inclusion list maintained for the message-designated recipient ID. E-mail messages from senders on the inclusion list can bypass the challenge protocol and be forwarded to the message-designated recipient ID. In particular implementations, periodically or on request, a digest of quarantined messages can be provided to the corresponding recipient ID to allow users an opportunity to manually augment the inclusion list.

### BRIEF DESCRIPTION OF THE DRAWINGS

FIG. 1 shows a networked computer environment in which the present invention is implemented;

FIG. 2 illustrates an embodiment of a mail server implementing the present invention;

FIG. 3 shows an embodiment of a mail client implementing the present invention;

FIG. 4 through FIG. 6 illustrate general structures of various message types involved in the practice of the present invention; and

FIG. 7 and FIG. 8 illustrate various actions performed in an implementation of the present invention; and

### DETAILED DESCRIPTION OF THE PREFERRED EMBODIMENTS

The present invention is illustrated and described in terms of an electronic messaging environment using public communication channels such as the Internet. However, an important feature of the present invention is that it is readily applied in a variety of public and private messaging environments and may be used in conjunction with industry standard messaging servers or proprietary messaging servers. Accordingly, unless specified to the contrary the present invention is applicable to significantly larger, more complex network environments as well as small network environments such as conventional LAN systems.

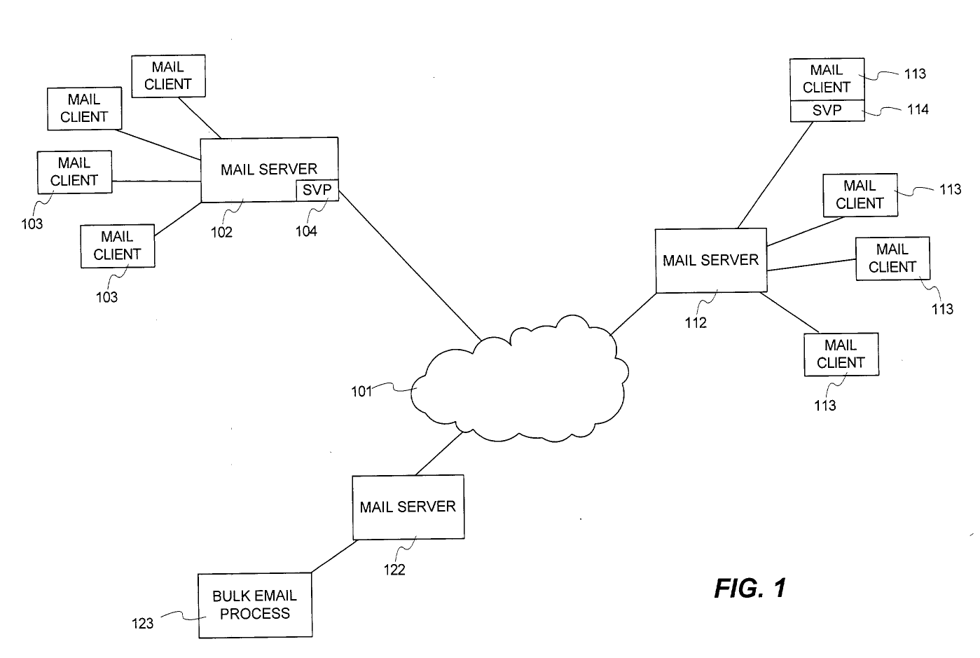

As shown in FIG. 1, e-mail is designed as a system for transporting messages between mail clients 103 and 113. Clients 103 and 113 implement client software that may vary from command-line processes to more familiar graphical interfaces that provide various functions to aid in message composition. In most cases, each client 103, 113 does not directly connect to a message recipient, but instead, accesses a mail server such as mail server 102, or mail server 113. A single mail server can transport messages between clients to which it is connected (i.e., mail server 102 can transport messages amongst clients 103). However, the present invention is primarily directed to applications in which two or more mail servers cooperatively transport messages (e.g., a message from a client 103 to a client 113) over a network such as Internet 101.

Mail servers 102, 112 and 122 implement processes for receiving e-mails from clients, routing messages to other mail servers, and delivering messages to designated recipients. A wide variety of e-mail server implementations are available, and the present invention is readily adapted to work with these various implementations. In general, e-mail that is transported over Internet 101 uses a protocol called “simple mail transfer protocol” or SMTP which can be embedded into TCP/IP packets used by Internet transport mechanisms. These specific protocols are merely examples, as other messaging protocols are readily adapted to implementation of the present invention.

SMTP was designed to transfer messages between two connected client computers, and so does not contain provisions for delivering messages when the recipient is not currently connected. Servers 102, 112 and 122 typically implement processes to implement store and forward capability on behalf of clients. For example, mail server 102 would implement processes to store messages received for clients 103, then deliver these stored messages when the client 103 later connects to mail server 102.

It should be understood that FIG. 1 illustrates various processes involved in mail delivery, but multiple processes may be implemented in a single computer. For example, one or more mail clients 103 may be implemented on the same computer as mail server 102. Likewise, processes may be implemented across multiple computers. For example, mail server 102 may implement processes involving sending messages on a first computer, and processes involving receiving messages on a second computer. The present invention is readily adapted to suit these various implementations.

As shown in FIG. 1, bulk e-mail processes 123 can use a substantially conventional mail server 122 for access to any client 103/113. Bulk e-mail processes 123 vary significantly in implementation and purpose, however, generally involve automated processes or “bots” that generate e-mail messages in large volume. Bulk e-mail processes 123 may access lists of e-mail addresses, or may automatically generate e-mail addresses, then sends unsolicited messages to the e-mail addresses. Because e-mail protocols are human readable and readily manipulated, it is easy for bulk e-mail processes 123 to obfuscate their identity, and the identity of mail server 122 to which they are connected. Although other information can be used to track a message back to the sending mail server 122, it typically takes so long to identify shut down bulk e-mail processes 123 that a great deal of damage has been done, and tens or hundreds of thousands of messages have already been distributed.

In accordance with the present invention, a sender verification protocol (SVP) is implemented at one or more locations in the message transport pathways, such as SVP 104 in mail server 102, and SVP 114 in a mail client 113. SVPs 104 and 114 implement processes that interrupt or postpone delivery of e-mail messages until the message sender passes a user-configurable challenge. Once a sender has passed the challenge, the sender's identification is added to an inclusion list. Subsequent messages will bypass the challenge protocol while the sender's ID remains on the inclusion list for the recipient. In this manner, an inclusion list protection is implemented where the list of senders is automatically generated with only optional user intervention and minimal user management.

In preferred implementations, SVPs 104 and 114 implement a challenge protocol that is readily performed by a human user, but is difficult to implement by an automated process. Preferably, the challenge is minimally intrusive on a human user sending one or a few e-mail messages, but becomes both logistically and resource intensive for bulk e-mailers 123. In this manner, the present invention provides not only passive disincentives by impeding or preventing delivery of bulk e-mail, but also provides active disincentives by imposing a cost in terms of time and computing resources required to respond to or otherwise divert, deflect, or challenge messages. Moreover, these costs will increase with the volume of e-mail delivered. As a result, the economics that have, until now, supported bulk e-mail practices are reversed as messages no longer have zero incremental cost to send.

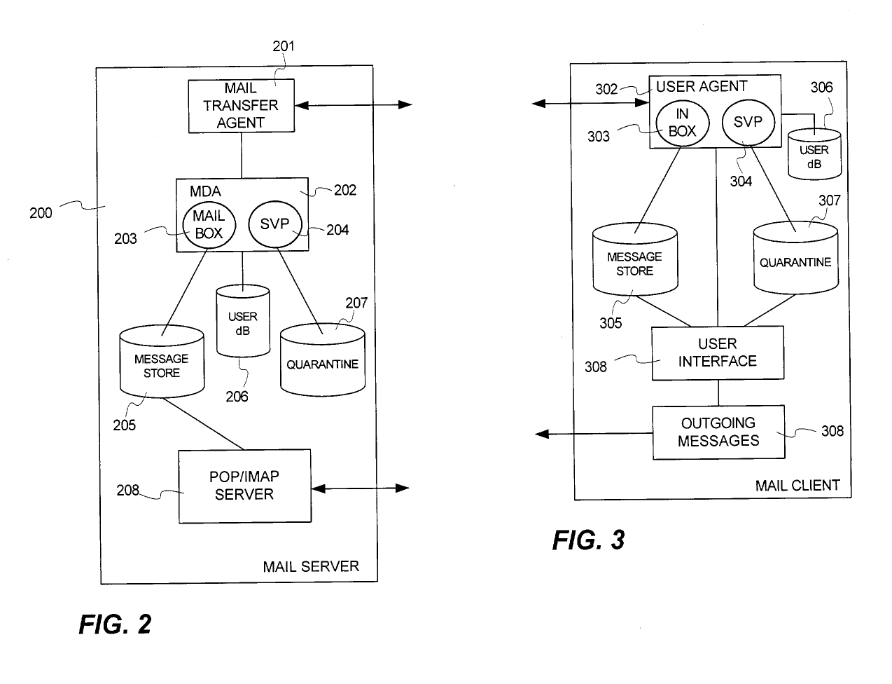

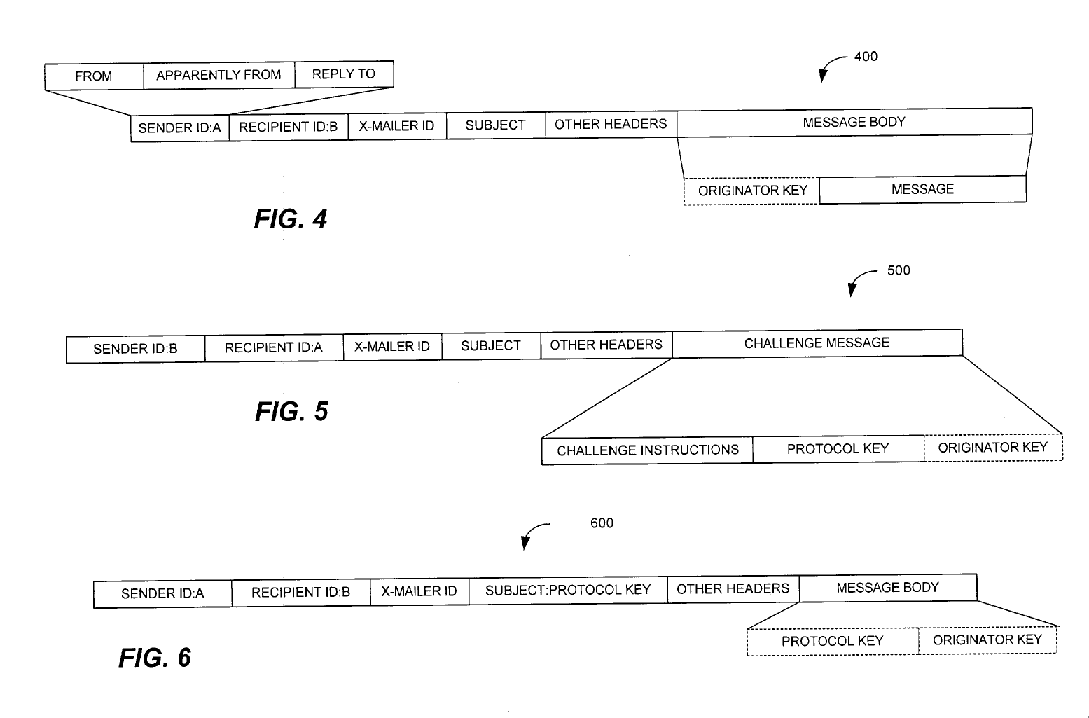

FIG. 2 and FIG. 3 illustrate exemplary implementations of a sender verification protocol in accordance with the present invention in both a mail server 200 (FIG. 2) and a mail client 300 (FIG. 3). The present invention contemplates that an SVP may be implemented in as few as one machine in the chain of machines that handle a given message, although an SVP may be implemented in multiple machines in the chain. Mail relaying by which one or more intermediate mail servers exist in the chain between a sender's mail server and a recipient's mail server is not shown to ease description and understanding. However, the present invention is compatible with such systems.

In FIG. 2, mail server 200 comprises a substantially conventional mail transfer agent (MTA) 201. MTA 201 is an example of a set of software processes that are responsible for processing incoming and outgoing e-mail messages. MTA 201 may be implemented, for example, by “sendmail”, which is currently the most popular MTA used in Internet mail servers. However, other MTA designs and products are equivalent substitutes. MTA 201 implements an interface to receive mail messages from mail clients via network 101. In the particular example, MTA 201 implements an SMTP interface, and processes to handle connection and handshaking protocols specified by Internet standards. MTA 201 parses received messages to identify header information in the message that identifies, for example, a recipient ID.

The recipient ID allows MTA 201 to determine, among other things, whether it is the final destination for the corresponding message, or whether the message needs to be sent to another MTA. Where MTA 201 is not the final MTA 201 for a received e-mail message, it will access network resources such as the domain name system (DNS) to determine an address of another MTA to which the message should be forwarded in a substantially conventional manner.

When the recipient ID corresponds to a recipient for which the mail server is a final destination, the message is handed off to a mail delivery agent (MDA) 202. Conventionally, MDA 202 implements “mail box” processes 203 that transfer received messages to a data storage structure (e.g., message store 205) in a manner that allows the messages to be retrieved on a per-user basis by mail clients. Message store 205 implements a “mail box” or “mail drop” for every recipient ID for which it is the final destination. Mail clients may retrieve messages from message store 205 using, for example, a post office protocol (POP) or Internet Mail Access protocol (IMAP) server 208 implemented within mail server 200. Other mechanisms for delivering messages from message store 205 are known, including other communication protocols, inter-process data communication methods, and direct file access, and are suitable equivalents for purposes of the present invention.

In accordance with the present invention, MDA 202 also includes SVP processes 204 and user configuration database 206 that implement the sender verification protocol in accordance with the present invention. SVP processes 204 access information in user configuration database 206 using any available communication mechanisms which are implementation specific. In particular, user database 206 maintains a list of trusted senders (e.g., an inclusion list).

SVP 204 determines whether the recipient ID for a received message corresponds to an entry in the list of trusted senders. This determination is made using any sender ID information extracted or derived from the message header. For example, various fields in an SMTP message are supposed to contain an accurate identification of a message sender such as a “From”, “Apparently From”, “Reply To” fields. Other fields contain this information in alternative mail protocols. When a corresponding entry is found, the message can be handled by mail box processes 203 in a substantially conventional manner.

However, a corresponding entry will not be found when the received message is from an unknown sender. In this case, SVP 204 initiates a challenge that is directed to the sender ID of the received message. This challenge involves sending a challenge message to the sender that requires the sender to perform some action and generate a challenge response message. The challenge message is sent out, for example, through MTA 201, and the challenge response message is received through MTA 201. Messages are stored in a quarantine data store 207 while waiting for a challenge response such that they are not delivered to a recipients mail box or mail drop. Upon receipt of a satisfactory challenge response, the message is moved from quarantine and handled in a substantially conventional manner by mailbox processes 203 to deliver the message to the intended recipient's mailbox or mail drop. In cases where a satisfactory challenge message is never received, SVP 204 includes processes for cleaning or garbage collection of quarantined messages. These processes may be automatic or user initiated, and may involve generating a log or digest of the contents of quarantined message store 207.

FIG. 3 illustrates a mail client 300 in which the sender verification protocol in accordance with the present invention is implemented. As in the case of mail server 200, many of the interfaces, functions, and behaviors of mail client 300 are substantially conventional so that mail client 300 is compatible with industry standard systems. User agent 302 comprises client software processes that retrieve incoming mail from a message store (e.g., message store 205) and send outgoing mail to an MTA 201. In box processes 303, which are roughly analogous to mail box processes 203, store incoming messages in a client-side message store 305 in a manner that enables the messages to be organized, retrieved, edited, and the like in a substantially conventional manner.

User agent 302 also includes SVP processes 304 that are analogous to SVP processes 204 described above. SVP processes 204 access information in user configuration database 306 using any available communication mechanisms which are implementation specific. In particular, user database 306 maintains a list of trusted senders (e.g., an inclusion list). SVP 304 determines whether the recipient ID for a received message corresponds to an entry in the list of trusted senders. When a corresponding entry is found, the message can be handled by in box processes 303 in a substantially conventional manner.

However, a corresponding entry will not be found when the received message is from an unknown sender. In this case, SVP 304 initiates a challenge that is directed to the sender ID of the received message. This challenge involves sending a challenge message to the sender that requires the sender to perform some action and generate a challenge response message. The challenge message is sent out, for example, through user agent 302, and the challenge response message is received through user agent 302. Messages are stored in a quarantine data store 307 while waiting for a challenge response such that they are not delivered to a recipient's in box. In one implementation, upon receipt of a satisfactory challenge response, the message is moved from quarantine and handled in a substantially conventional manner by in box processes 303 to deliver the message to the intended recipient's mailbox or mail drop.

The challenge response may be handled by SVP 304 immediately upon receipt to forward quarantined messages, or may require further intervention by a user and/or third party. For example, a received challenge response may trigger SVP 304 to send a “request for approval message” to a third party such as a parent, guardian, or IT department of a business. A request for approval message may be identified by an approval identifier in the subject line of the request for approval message. The subject of the approval request comprises a unique approval key and the body comprises, for example, a copy of all messages in the quarantine that are from the designated sender, and the user's originator key so that the approval response can be validated. The approval key is added to the pending approval keys list and the message is placed in the quarantine pending receipt of an approval response. Upon receipt of a response to the request for approval, the message(s) is (are) moved from quarantine and handled in a substantially conventional manner by in box processes 303 to deliver the message to the intended recipient's mailbox or mail drop. A satisfactory response should come from a previously approved source (e.g., the user ID associated with a parent's mail account or IT department). In this manner, supervisory control can be implemented by either the user or a third-party to control what senders are added to the trusted senders list. In cases where a satisfactory challenge message is never received, or a satisfactory approval message is never received, SVP 304 includes processes for cleaning or garbage collection of quarantined messages. These processes may be automatic or user initiated, and may involve generating a log or digest of the contents of quarantined message store 307.

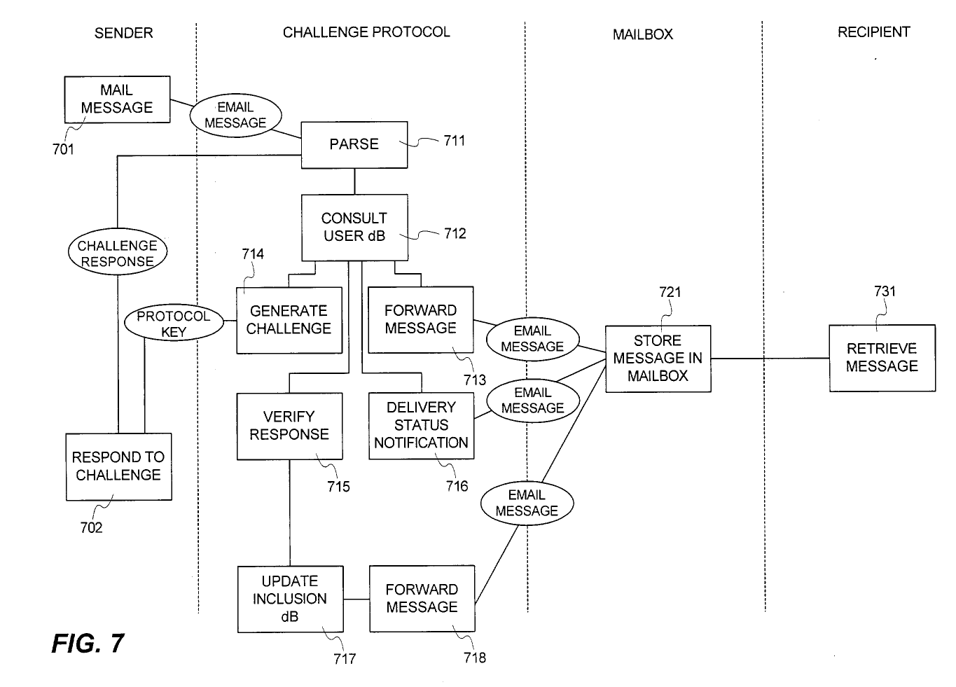

FIG. 4, FIG. 5, and FIG. 6 illustrate various message types that illustrate various features of the present invention using an SMTP-based implementation. Only some of the various header fields allowed by SMTP are shown to ease illustration and understanding, although it should be appreciated that in particular applications, any available header fields may be used as a basis for distinguishing known senders, and for storing information transferred in accordance with the protocol of the present invention. In FIG. 4, a mail message 400 using an Internet message format (e.g., as specified in IETF RFC 2822) comprises various message header field and a message body. A typical message 400 includes one or more fields that identify a sender labeled Sender ID in FIG. 4. For example, SMPT enables sender information to be carried in “FROM”, “Apparently From” and “Reply To” fields. The present invention contemplates that some or all of these Sender ID fields may be empty or include incorrect information as is typical of bulk e-mailers.

An X-Mailer ID field indicates the software process that generated the message and is an indicator of whether the message is an original message, or instead is an auto-reply message indicating mail was undeliverable, for example. The Subject field generally contains subject information specified by the sender. As noted before, other headers typically accompany a message.

The message body typically includes text, attachments, links, and the like that comprise the information the sender desires to convey to the recipient. In accordance with the present invention, senders who are using a sender verification protocol include an Originator Key value in the message body. The Originator Key comprises a string of a few characters or bytes of sufficient length to uniquely identify the user (e.g., a word, symbol or code that is associated with the user's name, organization and/or domain), which may or may not be the same as the user's recipient ID or network address. Preferably, the Originator Key is included in all outgoing messages generated by users that are using the present invention, but will not appear in mail messages sent by those who are not using the present invention, as suggested by the dashed-line illustration of the Originator Key in FIG. 4. An Originator Key that is associated with a single user will authenticate that the source of a message is that specific user. An Originator Key that is associated with an organization or domain will indicate that a message originated with a member of that organization or domain.

FIG. 5 illustrates a challenge message that is generated by a SVP when the sender ID is unknown to the SVP. A challenge message 500, illustrated in FIG. 5, transposes the sender and recipient IDs as compared to a received message so that it is addressed back to the sender of the original message. In a particular embodiment, the recipient ID is the sender ID of the original message, but it is contemplated that the sender ID could be changed to another address, such as a disposable e-mail address. Where the initial message included an Originator Key, that Originator Key is included in the message body of the challenge message. As described in greater detail below, this inclusion of the Originator Key prevents deadlock or livelock conditions in cases where both the sender and recipient have SVP protection.

The challenge message 500 and includes, for example, challenge instructions and a Protocol Key. In a particular example, the Protocol Key is an arbitrary, user-selected value. The challenge instructions state a simple human-performed task such as “Hello, the recipient of your message requires that you send a reply with the value XXXXXX in the subject line” where XXXXXX is the Protocol Key. The Protocol Key field, will appear in challenge messages (described below), but will not appear in typical messages sent by a sender or received by a recipient.

The Protocol Key field contains a value of arbitrary complexity. In on example, it is a text string that can be copied and pasted to the subject line. In alternative examples the Protocol Key may be embedded in a graphic, audio, or multimedia file that requires display to a human user to be comprehended.

By following the instructions the user will generate a suitable challenge response message 600 as shown in FIG. 6. The challenge response message 600 is characterized by contents that indicate that the challenge instructions of message 500 were followed correctly, or substantially correctly. For example, the subject field or message body may contain a value (e.g., the Protocol Key) that was required by the challenge instructions. Alternatively or in addition, the challenge response may be implemented in the message portion of a challenge response message, or in any other readily user-accessible field of the particular e-mail system used in a particular application.

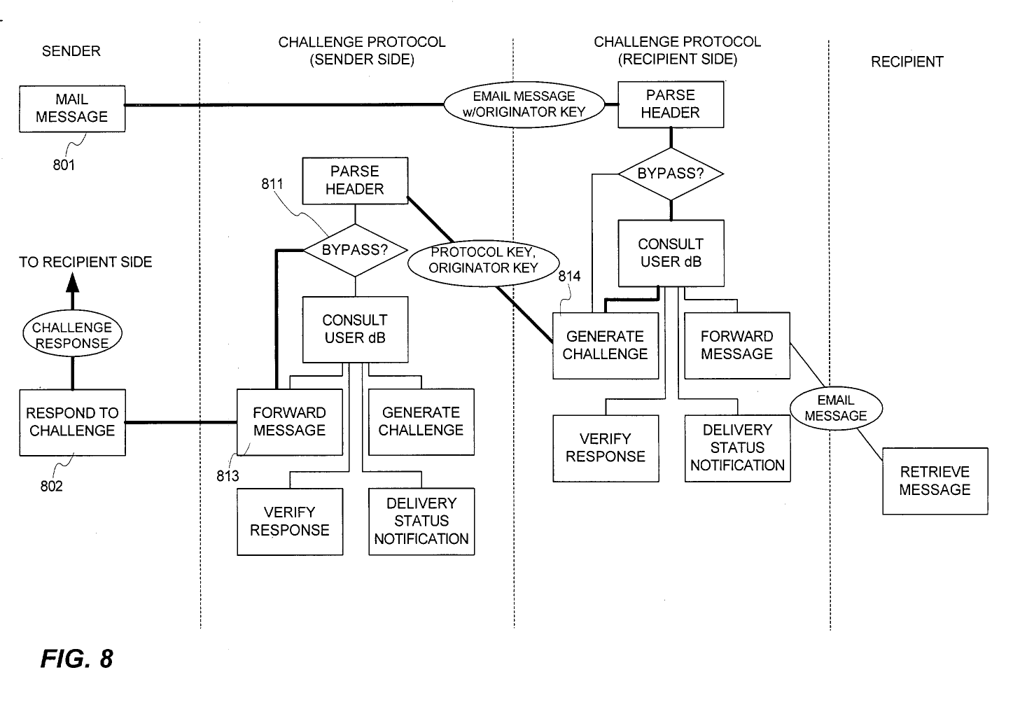

Operation of the present invention is described with reference to FIG. 7 and FIG. 8. FIG. 7 illustrates an implementation in which a single SVP protocol layer exists between a sender and a receiver, whereas FIG. 8 illustrates an implementation in which two SVP protocol layers exist between a sender and a receiver. Although FIG. 7 and FIG. 8 suggest uni-directional messaging from a sender to a receiver, it should be understood that in practical applications the processes are bi-directional. In other words, the SVP and other processes are configured to handle e-mail messages received from a sender, or from the Recipient (e.g., control, auto-response, replies, and the like).

At operation 701, the sender generates and sends an e-mail message (e.g., using format 500). The e-mail message is delivered to an appropriate MTA, and the message is parsed at 711. In operation, the system in accordance with the present invention processes all incoming messages to determine message type and disposition. Parsing 711 essentially “reads” the e-mail headers of interest. In operation 712, the e-mail header information is compared against data in the User database. Some determinations can be made based on global criteria that apply to all users, other determinations are performed on a user-by-user basis by accessing configuration data in the user database based upon the Recipient ID value of the message being processed.

In the case where the message sender is a member of a trusted sender list, or when the user option “web of trust” is selected and any of the recipients of the message are included on the trusted sender list, all of the recipients are added to the trusted sender list and messages are passed to operation 713 where the e-mail message is delivered to the user's message store in operation 721, essentially bypassing the challenge portion of the protocol in accordance with the present invention. The “web of trust” user option limits challenges for messages with multiple recipients such as messages addressed to a mail list. In this manner, the present invention imposes little if any perceptible delay to most messages when the message sender is known. A user retrieves messages from the message store by user processes 731 that can be implemented with substantially conventional user agent software.

In general, messages from senders that are not on the trusted sender list are considered to be from an untrusted sender. In the case where the message is the first message from the untrusted sender the system composes and sends a challenge message to the sender containing a unique Protocol Key in 714. The message header X-message-Type field value is set to ‘Challenge’. In a particular implementation, a message header called X-Control-Key is set to a system unique random value. The X-Control Key value is associated with a particular Protocol Key and is carried with the challenge message, and will be included in any delivery status notifications resulting from the challenge message. The SVP can then use the X-Control Key value as in index to identify a specific Protocol Key and thereby match a returned undeliverable challenge message with pending challenges and quarantined messages in operation 716, below. Without the X-Control Key functionality, it would be difficult or impossible to automatically determine which challenge requests had “bounced” and to initiate remedial action.

In the case where the message contains an Originator Key (indicating that although the sender is untrusted, it is using the SVP protocol in accordance with the present invention, a challenge message header called ‘X-Originator Key’ field is set to the Originator Key found in the message in order to allow the sender's system to recognize the authenticity of the challenge message. As another alternative, the entire original message, including the Originator Key, can be quoted as an attachment to the challenge request. This alternative approach simplifies message handling as there is no need to be aware of how to parse out the sender's Originator Key, and the sender side will already have knowledge of how to perform this parsing. In either case, the challenge message includes the sender's Originator Key which allows the sender's response to challenge processes 702 to forward the challenge message even when the challenge message appears to be from an untrusted source from the perspective of the sender's system. The challenge message body comprises instructions to the sender detailing how to identify the Protocol Key and compose the challenge response message. The Protocol Key is communicated in one of several methods based upon the challenge mode selected by the user.

The message is considered to be a delivery status notification when the message sender ID is “Mailer-Daemon” and message conforms to RFC 1894. Messages determined to be delivery status notifications are further examined in 716 to determine if the notification is in reference to a message sent by the user or as a result of a system generated challenge message. In the case where a returned message header contains a value in the X-Control Key field, the system sets a disposition flag for the Protocol Key associated with the value to “returned” and discards the associated message. In the case where a delivery status notification refers to a user's earlier message, as indicated by the presence of the user's Originator Key, the message is delivered to the users message store via process 716. In the particular example, all other delivery status notification messages are placed in the user's message quarantine. Delivery status messages preferably do not initiate the challenge processes.

In the particular example, the received message is considered to be a challenge response message in the case where the subject of the message contains a Protocol Key and handled by verify response operations 715. Alternatively, some other field or message data could be used to indicate a Protocol Key, but placing the Protocol Key in the subject line eases the tasks of parsing and identifying the Protocol Key. If the Protocol Key found in the challenge response message is a member of the pending Protocol Key list the Protocol Key is removed from the pending Protocol Key list and the user's trusted sender list is updated in operation 717. Messages in the message quarantine from the sender associated with the Protocol Key are removed from the message quarantine and delivered to the users message store in 718. Other challenge response messages are placed in the message quarantine.

The message is considered to be a challenge message from another SVP process in the case where the message header X-Message-Type field value is ‘Challenge’. For a challenge message to be considered authentic, the message header X-Originator Key field must match the user's Originator Key. Authentic challenge messages are delivered to the user's message store via process 713. All other challenge messages are placed in the message quarantine.

The message is considered to be an approval response where the message subject header contains an approval key and the designated sender is the address specified in the users approval address preference. The approval message is considered authentic if the message contains the users originator key and the approval key is found in the pending approval keys list. In the case where the approval message is considered authentic the approval key is removed from the pending approval list and the address associated with the approval key is marked as trusted and all messages in the quarantine from the associated with the approval key are delivered to the user's message store and the message is discarded. All other approval messages are place in the quarantine.

Although not detailed in FIG. 7, the present invention also contemplates a command process that enables a user to communicate with the SVP processes to perform maintenance functions and store configuration information in the user database. In a particular example, a message is considered to be a command message in the case where the message header Subject field value is the users Command password. The implemented commands for command message processing are defined as LIST, ADD, DELETE, CLEAN and RELEASE. The LIST and CLEAN command keywords have no arguments. For the ADD and DELETE commands to be considered valid the commands is followed by an argument of one or more sender address delimited by commas. For the RELEASE command to be considered valid the command is followed by one or more quarantined message identifiers delimited by commas. For the command message to be considered valid the body of the message body must contain one or more valid commands delimited by line breaks where the commands conform to the syntax for the implemented commands. Preferably, all of the commands except the LIST and CLEAN commands can be intermixed in a single message. In the case where the command message contains a valid LIST command the system places a message in the user's message store which details an inventory of all of the message in the user's message quarantine. In the case where the command message contains a valid ADD command the senders provided in the argument list to the ADD command are added to the trusted sender list. In the case where the command message is a valid DELETE command the senders detailed in the argument list of the DELETE command are removed from the trusted senders list. In the case where the command message contains a valid CLEAN command the system removes all message in the quarantine u to and including the last message detailed in the last list message issued. In the case where the command message contains a valid RELEASE command the messages detailed in the RELEASE argument list are removed from the quarantine and placed in the users message store. In the case where the command message had malformed syntax or any of the commands in the command message could not be completed the system places a command error message in the user's message store detailing the errors.

The message is considered to be a self-addressed message in the case where the message sender is the user (e.g., when a sender includes himself or herself in the “to”, “cc” or “bee” fields). For a self-addressed message to be considered authentic the message must contain the user's Originator Key. Authentic self-addressed messages are delivered to the user's message store via process 713. All other self-addressed messages are placed in the message quarantine.

Optionally, the designated recipients listed in a self-addressed message containing a proper Originator Key are added to the trusted sender list to enable the sender list to be populated somewhat automatically. Another option for automatically populating the approved sender list would allow all recipients identified in a message to be added to the trusted sender list when any one of the recipients (or a quorum of recipients) is/are already on the trusted sender list. As noted above, it is contemplated that the Originator Key may have portions associated with an organization or domain as well as portions associated with a particular user. When an organization is associated with the originator key, the organization can be added to the trusted sender list so that messages from any member of the organization are delivered to the user. Optionally, when the message sender address is in the same organization/domain as the user (i.e., recipient), all of the recipients identified in a message are placed on the trusted sender list.

FIG. 8 describes operation when two SVP processes are involved, one on the sender side and one on the recipient side. In this case, a potential problem exists when both sender and receiver are unknown or untrusted by each other. This could be handled by forcing the recipient ID to be added to a senders trusted sender database upon sending a message, however, such a solution requires manipulation of the MTA processes that may be undesirable or impractical. In a preferred implementation shown in FIG. 8, a message containing the sender's Originator Key generated at 801 is processed by the recipient-side SVP processes. Bold lines in FIG. 8 indicate the flow with respect to the particular example described herein. As described above, the message is handled by processes 814 in the case of an unknown sender to generate a challenge message that contains the Originator Key as well as the Protocol Key.

On the sender-side SVP, the parsed challenge message is examined to determine if it contains a known Originator Key at 811. A challenge message with a known Originator Key is allowed to bypass the challenge mechanism even if the sender of the challenge message (i.e., the recipient of the original message) is unknown. Forward message processes 813 transfer the challenge message to the original sender's mailbox (not shown), where it can be retrieved and responded to by the sender at 802. Further processing of the challenge response and handling of the original message is performed substantially as described in reference to FIG. 7.

The particular examples herein use a sender ID field as an indicator to distinguish trusted and untrusted senders. However, it is contemplated that other indicators may be used. For example, the sender ID may be used with wildcard characters, and the like such that ranges or groups of trusted senders can be established. This may be useful in organizations to avoid a significant volume of challenge protocol traffic in response to internal e-mail traffic. In another alternative, a message may contain an “organization key” that is shared across an entire organization or sub-unit within an organization. When a message contains the organization key, it can be allowed a one-time pass through to the recipient thereby bypassing validation processes. Because this is a “one-time pas through, the recipient IDs are not added to the trusted sender lists and subsequent messages will require validation through the SVP processes in accordance with the present invention. As yet another alterative, other header fields, subject field text, attachment types, message contents and the like can be used to identify trusted senders in particular applications. For example, a presence of digital signature or certificate, or encrypted contents may be treated as “per se” trusted in particular applications irrespective of the sender's ID as indicated in the message fields. Using these alternative indicia of trusted senders can be implemented, for example, by processes that bypass the challenge processes in a manner similar to bypass 801 in FIG. 8.

Although the present invention is presented in terms of a system that works independently of public exclusion list technologies such as the RBL, it is readily adapted to work in conjunction with such systems. For example, the pending challenge database maintained on a per-user basis by the SVP is a useful source of real time or near real time information on sources of bulk e-mail. Based on the length of time or quantity of unsatisfied pending challenge's, a system like the RBL can be automatically updated, perhaps hours or days before conventional update processes are in effect. Moreover, when the SVP is implemented on a mail server, the pending challenge data from a plurality of users can be aggregated to increase sensitivity and reduce the time required to detect an ongoing bulk e-mail campaign. Further, it is contemplated that other actions may be taken in response to unsatisfied pending challenges such as automated notifications to Internet Service providers, automated trace route processes to obtain more detailed information about e-mail abusers, and the like.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. An e-mail filter system comprising:
a protocol layer having an interface for receiving e-mail messages destined for a specified recipient, the e-mail messages containing a message-designated sender ID and a message-designated recipient ID;
a data structure holding indicia of recognized senders;
processes defined within the protocol layer for accessing the data structure upon receipt of an e-mail message and determining whether the received e-mail message is recognized;
in the case of a recognized e-mail message, forwarding the received e-mail message to the message-designated recipient ID; and
in the case of an unrecognized e-mail message, generating a challenge message to the message-designated sender ID.

2. The system of claim 1 further comprising processes defined within the protocol layer to postpone forwarding of the received e-mail message to the recipient ID until after an acceptable response to the challenge message has been received by the protocol layer.

3. The system of claim 1 wherein the protocol layer is implemented in computer processes executing in a mail server.

4. The system of claim 1 wherein the protocol layer is implemented in computer processes executing in a client computer.

5. A method for sending e-mail messages comprising:
transmitting an e-mail message to a mail server, wherein the e-mail message designates a recipient; and
causing a challenge message generated by the mail server prior to delivery of the e-mail message to be ignored.

6. The method of claim 5 wherein the transmitting is performed with knowledge that the recipient does not recognize the message specified sender ID.

7. A method for sending e-mail messages comprising:
transmitting an e-mail message to a mail server, wherein the e-mail message designates a recipient; and
receiving a challenge message generated by the mail server prior to delivery of the e-mail message; and
responding to the challenge message in an automated fashion.

8. A method of handling e-mail messages comprising:
receiving an e-mail message designating a sender ID;
determining whether the designated sender is a trusted sender; and
when the e-mail message does not designate a trusted sender, initiating a challenge process with the designated sender.

9. The method of claim 8 wherein the act of determining whether the designated sender is a trusted sender further comprises:
parsing at least a portion of the e-mail message to extract the sender ID;
comparing the extracted sender ID to a list of trusted senders; and
forwarding the message to a message-designated recipient upon finding a match in the comparing operation.

10. The method of claim 8 wherein the act of initiating a challenge process further comprises:
generating a challenge message addressed to the sender ID;
receiving a response to the challenge message from the sender ID;
evaluating the response to determine whether it satisfies the challenge message; and
upon receiving a satisfactory response to the challenge message, forwarding the senders message to a message designated recipient.

11. The method of claim 10 further comprising wherein the challenge message includes a Protocol Key and challenge instructions.

12. The method of claim 11 wherein the Protocol Key comprises text in the challenge message body and the challenge instructions call for the Protocol Key to be copied into the subject line of a response message.

13. The method of claim 11 wherein the Protocol Key comprises a graphic image in the challenge message body.

14. The method of claim 11 wherein the Protocol Key comprises an audio file in the challenge message body.
